(19) United States
(12) Patent Application Publication
(10) Pub. No.: US 2025/0218444 A1
(43) Pub. Date: Jul. 3, 2025

(54) ELECTRONIC DEVICE FOR PERFORMING VOICE RECOGNITION AND OPERATING METHOD THEREOF

(71) Applicant: SAMSUNG ELECTRONICS CO., LTD., Suwon-si (KR)

(72) Inventors: Taehong KIM, Suwon-si (KR); Mihye KIM, Suwon-si (KR); Yongjin KIM, Suwon-si (KR)

(73) Assignee: SAMSUNG ELECTRONICS CO., LTD., Suwon-si (KR)

(21) Appl. No.: 18/973,779

(22) Filed: Dec. 9, 2024

(30) Foreign Application Priority Data
Dec. 27, 2023 (KR) 10-2023-0193176

(51) Int. Cl. G10L 17/24

(52) U.S. Cl. CPC G10L 17/24

(57) ABSTRACT

An electronic device includes: a speaker configured to output an audio signal; a microphone configured to obtain a voice signal of a user; a first memory storing: a first voice recognition engine, a second voice recognition engine that is different from the first voice recognition engine, and instructions; a communication interface configured to establish wireless communication connections with a host device and an external electronic device; and at least one processor operatively connected to the speaker, the microphone, the first memory, and the communication interface, the at least one processor being configured to execute the instructions. The first voice recognition engine is commonly stored in the first memory and a second memory of the external electronic device, and the second voice recognition engine is different from voice recognition engines stored in the second memory.

### CROSS-REFERENCE TO RELATED APPLICATION

This application is based on and claims priority under 35 U.S.C. § 119 to Korean Patent Application No. 10-2023-0193176, filed on Dec. 27, 2023, in the Korean Intellectual Property Office, the disclosure of which is incorporated by reference herein in its entirety.

### BACKGROUND

The disclosure relates to an electronic device on which a plurality of voice recognition engines are separately stored and an operating method of the electronic device.

With the development of wireless communication technology, devices (for example, mobile terminals, smartphones, or wearable devices) provide various wireless functions. For example, a smartphone may provide various functions, such as a short-range wireless communication (e.g., Bluetooth™, Wi-Fi™, or near field communication (NFC)) function, a mobile communication (Third Generation (3G), Fourth Generation (4G), or Fifth Generation (5G)) function, a music or video playback function, a camera function, or a navigation function, in addition to basic voice communication functions.

Recently, the interest in wearable devices providing various types of services (e.g., a voice recognition-based service) by wirelessly linking with the above devices (e.g., mobile terminals, smartphones, or wearable devices) has increased. A true wireless stereo (TWS) device is a completely wireless stereo device, which refers to an electronic device for inputting/outputting sound signals. Although wireless devices in the related art used shared hardware modules (e.g., controllers, batteries, or the like), sub-devices (e.g., a first sub-device (left)/a second sub-device (right)) included in a TWS device may operate each hardware module together or independently depending on settings.

However, a TWS device is limited to having only two types of voice recognition engines (e.g., Samsung Bixby and Google Assistant) mounted thereon due to limitations in memory capacity within the device. Accordingly, a TWS device capable of storing a plurality of various voice recognition engines is required.

### SUMMARY

Embodiments of the disclosure provide an electronic device capable of providing various services based on a plurality of voice recognition engines by separately stored the plurality of voice recognition engines on an electronic device (e.g., a left-sided sound device) and an external electronic device (e.g., a right-sided sound device), and an operating method of the electronic device.

Aspects of the present disclosure are not limited to the aspects stated above, and other aspects that are not mentioned may be clearly understood by those skilled in the art from the following description.

According to an aspect of one or more example embodiments, an electronic device may include: a speaker configured to output an audio signal; a microphone configured to obtain a voice signal of a user; a first memory storing: a first voice recognition engine, a second voice recognition engine that is different from the first voice recognition engine, and instructions; a communication interface configured to establish wireless communication connections with a host device and an external electronic device; and at least one processor operatively connected to the speaker, the microphone, the first memory, and the communication interface, the at least one processor being configured to execute the instructions. The first voice recognition engine may be commonly stored in the first memory and a second memory of the external electronic device, and the second voice recognition engine may be different from voice recognition engines stored in the second memory.

According to aspect of one or more example embodiments, an electronic device may include: a speaker configured to output an audio signal; a microphone configured to obtain a voice signal of a user; a first memory storing a first voice recognition engine, a second voice recognition engine that is different from the first voice recognition engine, and instructions; a communication interface configured to establish wireless communication connections with a host device and an external electronic device; and at least one processor operatively connected to the speaker, the microphone, the first memory, and the communication interface, the at least one processor being configured to execute the instructions. The first voice recognition engine and the second voice recognition engine are different from voice recognition engines stored in a second memory of the external electronic device.

According to an aspect of one or more example embodiments, an electronic device may include: a first sub-device; and a second sub-device. The first sub-device may include: a first speaker configured to output a first sound signal; a first microphone; a first wireless communication circuit configured to connect to the second sub-device via wireless communication; a first memory storing a first voice recognition engine, a second voice recognition engine that is different from the first voice recognition engine, and first instructions; and at least one first processor operatively connected to the first speaker, the first microphone, the first wireless communication circuit, and the first memory, the at least one first processor being configured to execute the first instructions. The second sub-device may include: a second speaker configured to output a second sound signal; a second microphone; a second wireless communication circuit configured to connect to the first wireless communication circuit via wireless communication; a second memory storing a third voice recognition engine, a fourth voice recognition engine that is different from the third voice recognition engine, and second instructions; and at least one second processor operatively connected to the second speaker, the second microphone, the second wireless communication circuit, and the second memory, the at least one second processor being configured to execute the second instructions. The first voice recognition engine may be same as or different from the third voice recognition engine, and the second voice recognition engine may be different from the fourth voice recognition engine.

### BRIEF DESCRIPTION OF THE DRAWINGS

Embodiments of the disclosure will be more clearly understood from the following detailed description taken in conjunction with the accompanying drawings, in which:

FIG. 1 is a diagram illustrating an example in which an electronic device and an external electronic device are connected to a host device via wireless communication, according to one or more embodiments;

FIG. 2 is a block diagram of an electronic device according to one or more embodiments;

FIG. 3A shows structures of voice recognition engines mounted on an electronic device and an external electronic device, according to a comparative example;

FIG. 3B shows structures of voice recognition engines mounted on an electronic device and an external electronic device, according to one or more embodiments;

FIG. 3C shows structures of voice recognition engines mounted on an electronic device and an external electronic device, according to one or more embodiments;

FIG. 3D shows structures of voice recognition engines mounted on an electronic device and an external electronic device, according to one or more embodiments;

FIG. 4 shows division units of an electronic device and an external electronic device, according to one or more embodiments;

FIG. 5 shows a command processing method of an electronic device and an external electronic device, according to one or more embodiments;

FIG. 6 is a flowchart illustrating a command processing method between a host device, an electronic device, and an external electronic device, according to one or more embodiments;

FIG. 7 is a flowchart illustrating a method of performing voice recognition between a host device, an electronic device, and an external electronic device, according to a comparative example;

FIG. 8 is a flowchart illustrating a method of performing voice recognition between a host device, an electronic device, and an external electronic device, according to one or more embodiments; and

FIG. 9 shows a wireless network environment including an electronic device according to one or more embodiments.

### DETAILED DESCRIPTION

Example embodiments of the disclosure will now be described more fully with reference to the accompanying drawings. The disclosure may, however, be embodied in many different forms and should not be construed as being limited to the example embodiments set forth herein. Rather, these embodiments are provided so that the disclosure will be thorough and complete, and will fully convey the concept of the disclosure to those skilled in the art.

Elements described as “modules” or “part” may be physically implemented by analog and/or digital circuits including one or more of a logic gate, an integrated circuit, a microprocessor, a microcontroller, a memory circuit, a passive electronic component, an active electronic component, and the like.

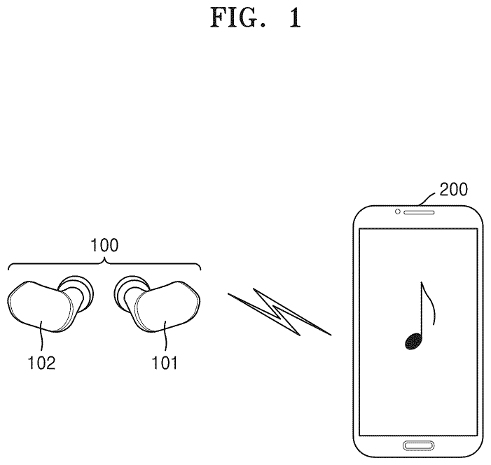

FIG. 1 is a diagram illustrating an example in which an electronic device and an external electronic device are connected to a host device via wireless communication, according to one or more embodiments.

Referring to FIG. 1, according to one or more embodiments, a device set 100 including an electronic device 101 and an external electronic device 102 may be an audio output device capable of outputting audio signals. For example, the device set 100 may be worn on a user's body and may include hearable devices (e.g., the electronic device 101 and the external electronic device 102) that may output audio signals. The electronic device 101 may be a wireless earphone for outputting a left-sided sound signal, and the external electronic device 102 may be a wireless earphone for outputting a right-sided sound signal. The electronic device 101 may be a primary device capable of receiving commands/events from a host device 200 and transmitting the commands/events to a secondary device, and the external electronic device 102 may be a secondary device that performs a function by receiving a command/event from the host device 200 through a primary device (e.g., the electronic device 101). The device set 100 may include a pair of sub-devices (e.g., the electronic device 101 and the external electronic device 102), and the pair of sub-devices (e.g., the electronic device 101 and the external electronic device 102) may be connected to each other through a short-range wireless communication (e.g., Bluetooth) channel.

The device set 100 may be connected to the host device 200 (e.g., a terminal) through a short-range wireless communication (e.g., Bluetooth) channel. The electronic device 101 and the external electronic device 102 may receive and output audio data (e.g., music data, audio data included in a video, and call reception data) from the host device 200 through a short-range wireless communication channel. In one or more embodiments, the electronic device 101 and the external electronic device 102 may output audio data stored in the internal memory thereof.

In one or more embodiments, the electronic device 101 and the external electronic device 102 may, in response to a voice recognition activation command received from the host device 200, activate at least one input device (e.g., a microphone) to obtain external sound and use a voice recognition engine mounted on each device to detect at least one designated keyword (e.g., ‘Hi Bixby’, etc.) from the external sound. When at least one designated keyword is detected from the external sound, the electronic device 101 and/or the external electronic device 102 may transmit detected keyword information to the host device 200, and the host device 200 may perform a function corresponding to the keyword information.

A device and method according to one or more embodiments may allow various types of voice recognition engines to be mounted thereon despite limited memory capacity, and may provide a user with various voice recognition-based services based on the voice recognition engines by separately stored a plurality of voice recognition engines on the electronic device 101 and the external electronic device 102.

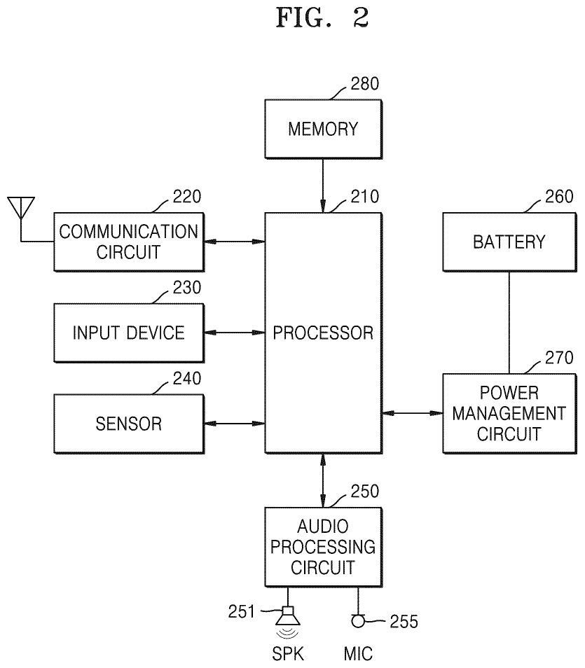

FIG. 2 is a block diagram of an electronic device according to one or more embodiments.

In one or more embodiments, the configurations shown in FIG. 2 may be included in the electronic device 101. The external electronic device 102 (refer to FIG. 1) that is paired with the electronic device 101 and worn on the right ear may include a configuration corresponding to the electronic device 101 to be described below.

Referring to FIG. 2, the electronic device 101 may include a processor 210, a communication circuit 220, an input device 230, a sensor 240, an audio processing circuit 250, a speaker 251, a microphone 255, a battery 260, a power management circuit 270, a memory 280, or a combination thereof.

In one or more embodiments, the processor 210 may control overall operations of the electronic device 101. The processor 210 may receive data from other components of the electronic device 101 (e.g., the communication circuit 220, the input device 230, the audio processing circuit 250, the power management circuit 270, or the memory 280), interpret the received data, and perform calculations/functions according to the interpreted data.

In one or more embodiments, the processor 210 may control the communication circuit 220 so that the electronic device 101 establishes a wireless communication connection (e.g., Bluetooth pairing) with the host device 200 (refer to FIG. 1). In one or more embodiments, the wireless communication connection may be a link capable of bidirectional communication between the electronic device 101 and the host device 200. In one or more embodiments, the processor 210 may obtain data from the host device 200 by using the communication circuit 220 and transmit a response (e.g., ACK or NACK) indicating whether the data has been successfully received from the host device 200. In one or more embodiments, the wireless communication connection between the electronic device 101 and the host device 200 may be referred to as a first communication link. In one or more embodiments, the wireless communication connection between the external electronic device 102 and the host device 200 may be referred to as a second communication link. In one or more embodiments, the wireless communication connection between the electronic device 101 and the external electronic device 102 may be referred to as a third communication link.

In one or more embodiments, when a wireless communication connection is established between the electronic device 101 and the host device 200, the processor 210 may receive data from the host device 200 by using the communication circuit 220. In one or more embodiments, the data received from the host device 200 may be data including an audio signal.

In one or more embodiments, the processor 210 may provide data from the host device 200 to the audio processing circuit 250. In one or more embodiments, the audio processing circuit 250 may convert (for example, decode) the provided data into an audio signal and output the converted audio signal through the speaker 251.

In one or more embodiments, the processor 210 may transmit a mode parameter to a counterpart electronic device (e.g., the external electronic device 102) through a separate wireless communication connection. In one or more embodiments, the mode parameter may include information about a sound effect or audio filter applied to an audio signal when the audio signal corresponding to data from the host device 200 is output through the speaker 251. In one or more embodiments, the mode parameter may include information about an audio output intensity or audio output size applied to an audio signal. In one or more embodiments, the mode parameter may include information about the setting of an application that is being executed in connection with data in the host device 200. In one or more embodiments, the mode parameter may include information about a data channel (for example, in the case of a stereo audio signal, information about a left-sided (L) channel and information about a right-sided (R) channel).

In one or more embodiments, the electronic device 101 may monitor a wireless communication connection between a counterpart electronic device (e.g., the external electronic device 102) and the host device 200 by using a communication parameter, and may obtain (e.g., sniff) data transmitted and received between the counterpart electronic device (e.g., the external electronic device 102) and the host device 200 through the wireless communication connection being monitored.

In one or more embodiments, the processor 210 may output the data obtained from the host device 200 through the speaker 251. In one or more embodiments, the processor 210 may convert (decode) the obtained data into audio signals by using the audio processing circuit 250 and output the converted audio signals through the speaker 251. In one or more embodiments, the processor 210 may output audio signals related to one channel (e.g., an L channel) or all channels (e.g., an L channel and an R channel) allocated to the electronic device 101 among the converted audio signals through the speaker 251, according to the setting information of the electronic device 101.

In one or more embodiments, the communication circuit 220 may establish a wireless communication connection between the electronic device 101 and the external electronic device 102 and/or a wireless communication connection between the electronic device 101 and the host device 200. In one or more embodiments, the communication circuit 220 may receive data from the external electronic device 102 and/or the host device 200 through the established wireless communication connection. In one or more embodiments, the communication circuit 220 may transmit data to the external electronic device 102 and/or the host device 200 through the established wireless communication connection.

In one or more embodiments, the communication circuit 220 may access (or observe) the wireless communication connection between the external electronic device 102 and the host device 200 based on a communication parameter about the wireless communication connection between the external electronic device 102 and the host device 200. In one or more embodiments, the communication circuit 220 may obtain data transmitted and received through the wireless communication connection being accessed (or observed).

In one or more embodiments, the input device 230 may receive an input from a user. In one or more embodiments, the input received from the user may be an input for adjusting the volume of an audio signal output through the electronic device 101 or an input for playing the next song.

In one or more embodiments, the input device 230 may include a touch panel. In one or more embodiments, the input device 230 may detect a touch input or a hovering input by using the touch panel. In one or more embodiments, the input device 230 may include a physical key.

In one or more embodiments, the input device 230 may provide data indicating the input received from the user to the processor 210.

In one or more embodiments, the sensor 240 may generate a sensing value for identifying a communication connection event. In one or more embodiments, the communication connection event may include the wear of the electronic device 101, the detachment of the electronic device 101 from a case thereof, the use of the electronic device 101, a gesture input, or a combination thereof.

In one or more embodiments, the audio processing circuit 250 may process a signal related to sound. In one or more embodiments, the audio processing circuit 250 may obtain a sound signal (e.g., a voice signal of the user) through the microphone 255. In one or more embodiments, the audio processing circuit 250 may convert the voice signal obtained through the microphone 255 into an analog audio signal (or an electrical signal) corresponding to the voice signal. In one or more embodiments, the audio processing circuit 250 may encode the analog audio signal to a digital audio signal by using a codec. In one or more embodiments, the audio processing circuit 250 may provide the digital audio signal to other components (e.g., the processor 210, the communication circuit 220, and/or the memory 280) of the electronic device 101.

In one or more embodiments, the audio processing circuit 250 may receive a digital audio signal from other components (e.g., the processor 210, the communication circuit 220, an interface, and/or the memory 280) of the electronic device 101. In one or more embodiments, the audio processing circuit 250 may convert the digital audio signal into an analog audio signal through a converter (e.g., a digital-to-analog converter (DAC)). In one or more embodiments, the audio processing circuit 250 may decode a digital audio signal to an analog audio signal by using a codec. In one or more embodiments, the audio processing circuit 250 may output a sound signal corresponding to the analog audio signal through the speaker 251.

In one or more embodiments, the battery 260 may supply power to at least one component of the electronic device 101. In one or more embodiments, the battery 260 may be charged when the electronic device 101 is mounted on (or connected to) a designated charging device (e.g., a case).

In one or more embodiments, the power management circuit 270 may manage the power supplied to the electronic device 101 through the battery 260. For example, the power management circuit 270 may be configured as at least a part of a power management integrated circuit (PMIC).

In one or more embodiments, the power management circuit 270 may measure the power amount of the battery 260 of the electronic device 101. In one or more embodiments, the power management circuit 270 may provide information about the power amount of the battery 260 to the processor 210. In one or more embodiments, the processor 210 may transmit information about the remaining amount of the battery 260 of the electronic device 101 to the host device 200. In one or more embodiments, the power amount of the battery 260 of the electronic device 101 may be used to perform negotiations to determine a primary device between the electronic device 101 and the external electronic device 102. In one or more embodiments, based on the power amounts of the electronic device 101 and the external electronic device 102, one of the electronic device 101 and the external electronic device 102 may be determined as a primary device, and the other one may be determined/changed as a secondary device.

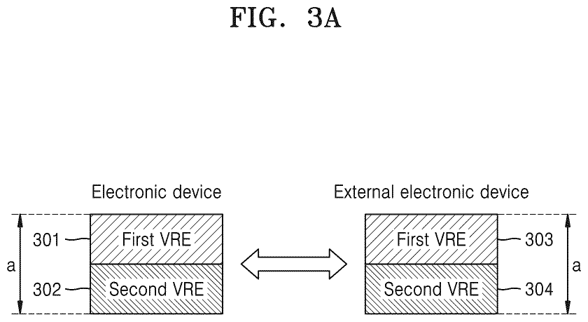

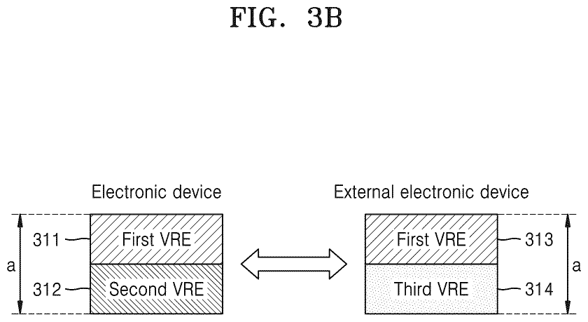

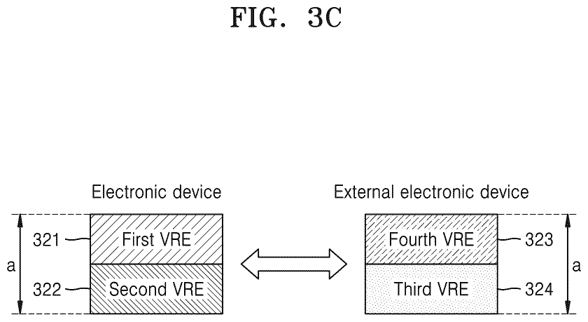

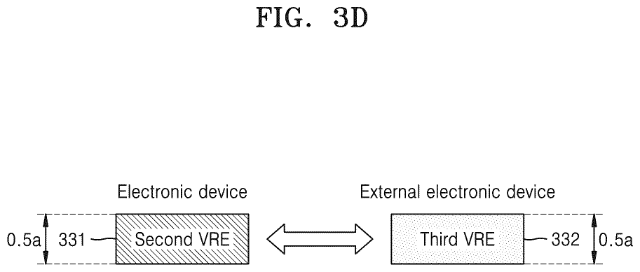

In one or more embodiments, the memory 280 may store (or be mounted with) a plurality of voice recognition engines. The plurality of voice recognition engines may be stored in the memory 280 in a pre-allocated space size. the processor 210 may update/change the plurality of voice recognition engines stored in the memory 280 based on the number of times of each of the plurality of voice recognition engines was used during a predetermined period (that is, the number of times of uses of the plurality of voice recognition engines) and a user setting. The structures of the plurality of voice recognition engines stored in the memory 280 are described below with reference to FIGS. 3A to 3D.

FIG. 3A shows structures of voice recognition engines mounted on an electronic device and an external electronic device, according to a comparative example.

In FIG. 3A, it is assumed that each of an electronic device and an external electronic device may store voice recognition engines (VRE) in two memory spaces (herein, the total size of the two spaces is ‘a’) pre-allocated in the memory for each device.

Referring to FIG. 3A, the electronic device according to the comparative example may store a first VRE in a pre-allocated first memory space 301 and a second VRE in a pre-allocated second memory space 302. The external electronic device may store the first VRE in a pre-allocated third memory space 303 and the second VRE in a pre-allocated fourth memory space 304. Here, it may be confirmed that the electronic device and the external electronic device commonly store the same types of first VRE and second VRE. For example, the electronic device and the external electronic device may commonly store ‘Bixby’ from company A and ‘Assistant’ from company B.

The electronic device according to the comparative example and the external electronic device may only store same types of VREs as the electronic device and the external electronic device may not operate independently (that is, the electronic device and the external electronic device must be coupled and operate together). In addition, since the number/type of VREs that may be stored in the electronic device and the external electronic device is limited, the types of voice recognition services that may be provided may also be limited.

FIG. 3B shows structures of voice recognition engines mounted on an electronic device and an external electronic device, according to one or more embodiments.

The electronic device 101 and the external electronic device 102 of FIG. 3B may correspond to the electronic device 101 and the external electronic device 102 of FIGS. 1 and 2.

In FIG. 3B, it is assumed that each of the electronic device 101 and the external electronic device 102 may store VREs in two memory spaces (herein, the total size of the two spaces is ‘a’) pre-allocated in the memory for each device.

Referring to FIG. 3B, the electronic device 101 according to one or more embodiments may store a first VRE in a pre-allocated first memory space 311 and a second VRE in a pre-allocated second memory space 312. The external electronic device 102 may store the first VRE in a pre-allocated third memory space 313 and a third VRE in a pre-allocated fourth memory space 314. Here, the electronic device 101 and the external electronic device 102 may commonly store the same type of first VREs, and the electronic device 101 and the external electronic device 102 may respectively store the second VRE and the third VRE, which are different types. For example, the electronic device 101 and the external electronic device 102 may commonly store ‘Bixby’ of company A. The electronic device 101 may store ‘Assistant’ of company B, and the external electronic device 102 may store ‘Alexa’ of company C (this is an example for convenience of explanation, and the VREs stored in the electronic device 101 according to one or more embodiments and the external electronic device 102 are not limited thereto). The state of the VREs stored in the memory of the electronic device 101 of FIG. 3B and the state of the VREs stored in the memory of the external electronic device 102 may be exchanged.

In one or more embodiments, the VREs commonly stored in the electronic device 101 and the external electronic device 102 may be selected from a plurality of VREs, based on the number of times each VRE was used during a predetermined period and/or the user setting.

In one or more embodiments, the processor of the electronic device 101 may sort the VREs based on the number of times of uses of each of the plurality of VREs, select a VRE with the greatest number of times of uses among the plurality of VREs as a VRE to be commonly stored in the electronic device 101 and the external electronic device 102 (for example, a VRE stored in the first memory space 311 of the electronic device 101 and the third memory space 313 of the external electronic device 102) based on a sorting result, and select a VRE′ with the greatest number of times of uses next to the selected VRE as a VRE to be stored only in the electronic device 101 (for example, a VRE stored in the second memory space 312 of the electronic device 101). In the external electronic device 102, VREs to be stored in the third memory space 313 and the fourth memory space 314 may also be selected according to the above embodiment.

In one or more embodiments, the processor of the electronic device 101 may change the VREs stored in the first memory space 311 and the second memory space 312 of the electronic device 101 based on any one of the number of times of uses for each VRE during a period after the predetermined period and/or the user setting (that is, the VREs stored in the first memory space 311 and the second memory space 312 may be updated based on any one of the number of times of uses for each VRE during a period after the predetermined period and/or the user setting). In the external electronic device 102, the VREs to be stored in the third memory space 313 and the fourth memory space 314 may also be changed/updated according to the above embodiment.

In one or more embodiments, a VRE to be commonly stored in the electronic device 101 and the external electronic device 102 may be selected from a plurality of VREs based on at least one of the market share for each VRE at the time of manufacture and/or the user preference for each VRE at the time of manufacture.

As the electronic device 101 according to one or more embodiments and the external electronic device 102 may operate independently for each device, the electronic device 101 and the external electronic device 102 may separately store different types of VREs while commonly storing the same type of VREs. Accordingly, the electronic device 101 according to one or more embodiments and the external electronic device 102 may store various types of VREs in a limited memory space and may accordingly provide the user with various voice recognition services.

FIG. 3C shows structures of voice recognition engines mounted on an electronic device and an external electronic device, according to one or more embodiments.

The electronic device 101 and the external electronic device 102 of FIG. 3C may correspond to the electronic device 101 and the external electronic device 102 of FIGS. 1 and 2.

In FIG. 3C, it is assumed that each of the electronic device 101 and the external electronic device 102 may store VREs in two memory spaces (herein, the total size of the two spaces is ‘a’) pre-allocated in the memory for each device.

Referring to FIG. 3C, the electronic device 101 according to one or more embodiments may store a first VRE in a pre-allocated first memory space 321 and a second VRE in a pre-allocated second memory space 322. The external electronic device 102 may store a fourth VRE in a pre-allocated third memory space 323 and a third VRE in a pre-allocated fourth memory space 324. Here, the electronic device 101 and the external electronic device 102 may not commonly store the same type of VREs, and the electronic device 101 and the external electronic device 102 may respectively store first to fourth VREs, which are different types. For example, the electronic device 101 may store ‘Bixby’ of company A and ‘Assistant’ of company B, and the external electronic device 102 may store ‘Alexa’ of company C and ‘Siri’ of company D (this is an example for convenience of explanation, and the VREs stored in the electronic device 101 according to one or more embodiments and the external electronic device 102 are not limited thereto). The state of the VREs stored in the memory of the electronic device 101 of FIG. 3C and the state of the VREs stored in the memory of the external electronic device 102 may be exchanged.

In one or more embodiments, the processor of the electronic device 101 may sort the VREs based on the number of times of uses of each of the plurality of VREs, and may select, based on a sorting result, VREs to be stored in the first memory space 321 and the second memory space 322 according to an order of the greatest number of times of uses among the plurality of VREs. For example, the processor may select, based on the sorting result, a VRE with the greatest number of times of uses among the plurality of VREs as a VRE to be stored in the first memory space 321 of the electronic device 101, and may select a VRE′ with the greatest number of times of uses next to the selected VRE as a VRE to be stored in the second memory space 322 of the electronic device 101. In the external electronic device 102, VREs to be stored in the third memory space 323 and the fourth memory space 324 may also be selected according to the above embodiment.

In one or more embodiments, the processor of the electronic device 101 may change the VREs stored in the first memory space 321 and the second memory space 322 of the electronic device 101 based on any one of the number of times of uses for each VRE during a period after the predetermined period and/or the user setting (that is, the VREs stored in the first memory space 321 and the second memory space 322 may be updated based on any one of the number of times of uses for each VRE during a period after the predetermined period and/or the user setting). In the external electronic device 102, the VREs to be stored in the third memory space 323 and the fourth memory space 324 may also be changed/updated according to the above embodiment.

In one or more embodiments, a VRE to be commonly stored in the electronic device 101 and the external electronic device 102 may be selected from a plurality of VREs based on at least one of the market share for each VRE at the time of manufacture and/or the user preference for each VRE at the time of manufacture.

As the electronic device 101 according to one or more embodiments and the external electronic device 102 may operate independently for each device, the electronic device 101 and the external electronic device 102 may separately store different types of VREs for each device. Accordingly, the electronic device 101 according to one or more embodiments and the external electronic device 102 may store various types of VREs in a limited memory space and may accordingly provide the user with various voice recognition services.

FIG. 3D shows structures of voice recognition engines mounted on an electronic device and an external electronic device, according to one or more embodiments.

The electronic device 101 and the external electronic device 102 of FIG. 3D may correspond to the electronic device 101 and the external electronic device 102 of FIGS. 1 and 2.

In FIG. 3D, it is assumed that each of the electronic device 101 and the external electronic device 102 may store VREs in two memory spaces (herein, the total size of the two spaces is ‘0.5a’) pre-allocated in the memory for each device.

Referring to FIG. 3D, the electronic device 101 according to one or more embodiments may store a second VRE in a pre-allocated first memory space 331. The external electronic device 102 may store a third VRE in a pre-allocated third memory space 333. Here, the electronic device 101 and the external electronic device 102 may not commonly store the same type of VREs, and the electronic device 101 and the external electronic device 102 may respectively store the second VRE and the third VRE, which are different types. For example, the electronic device 101 may store ‘Assistant’ of company B, and the external electronic device 102 may store ‘Alexa’ of company C (this is an example for convenience of explanation, and the VREs stored in the electronic device 101 according to one or more embodiments and the external electronic device 102 are not limited thereto). The state of the VRE stored in the memory of the electronic device 101 of FIG. 3D and the state of the VRE stored in the memory of the external electronic device 102 may be exchanged.

In one or more embodiments, the processor of the electronic device 101 may select/change a VRE to be stored in the first memory space 331 based on at least one of the number of times of uses for each VRE in a predetermined period and/or the user setting.

As the electronic device 101 according to one or more embodiments and the external electronic device 102 may operate independently for each device, the electronic device 101 and the external electronic device 102 may separately store different types of VREs for each device. Accordingly, the electronic device 101 according to one or more embodiments and the external electronic device 102 may store various types of VREs in a limited memory space and may accordingly provide the user with various voice recognition services.

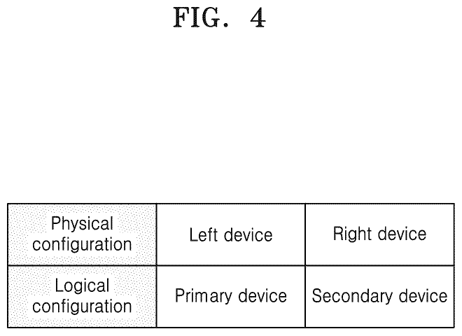

FIG. 4 shows division units of an electronic device and an external electronic device, according to one or more embodiments.

The electronic device 101 and the external electronic device 102 of FIG. 4 may correspond to the electronic device 101 and the external electronic device 102 of FIGS. 3B to 3D.

FIG. 4 shows a table for describing the division units between devices in a command processing process between the host device 200 (refer to FIG. 1), the electronic device 101, and the external electronic device 102.

First, in terms of the physical division configuration (or division unit), the electronic device 101 and the external electronic device 102 may be divided into a left device worn on the user's left ear and a right device worn on the user's right ear. That is, the electronic device 101 and the external electronic device 102 may be divided according to the shapes or operation positions of the devices in terms of the physical configuration. For example, when the electronic device 101 is a left device, the shape and the operation position of the device may be configured to output a left-sided sound signal received from the host device 200 to the user. For example, when the external electronic device 102 is a right device, the shape and the operation position of the device may be configured to output a right-sided sound signal received from the host device 200 to the user.

Next, in terms of the logical configuration (or division unit), the electronic device 101 and the external electronic device 102 may be divided into a primary device and a secondary device. For example, when the electronic device 101 is a primary device, the electronic device 101 may perform command processing and voice signal and/or voice data processing received from the host device 200 based on wireless communication connection with the host device 200. For example, when the external electronic device 102 is a secondary device, the external electronic device 102 may receive and process commands or voice data from the primary device (e.g., the electronic device 101).

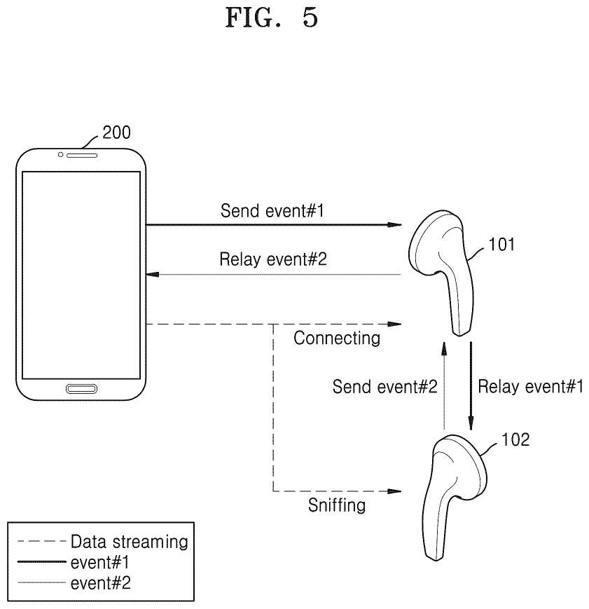

FIG. 5 shows a command processing method of an electronic device and an external electronic device, according to one or more embodiments.

In FIG. 5, the dotted line may indicate data streaming, the bold solid arrow may indicate a delivery route of a first event (event #1), and the soft solid arrow may indicate a delivery route of a second event (event #2). At this time, the first event (event #1) may mean a command (e.g., volume-up) generated from the host device 200, and the second event (event #2) may mean a command (e.g., pause) generated from the electronic device 101 or the external electronic device 102.

In FIG. 5, for convenience of explanation, it is assumed that the electronic device 101 is a primary device, and the external electronic device 102 is a secondary device. But, according to the situation of the devices (e.g., the battery capacity for each device), the external electronic device 102 may be changed to the primary device.

Referring to FIG. 5, when the first event (event #1) (e.g., volume-up) is generated from the host device 200, the host device 200 may transmit the first event (event #1) to the electronic device 101. The electronic device 101 may perform a function corresponding to the first event (event #1) in response to the reception of the first event (event #1). For example, the electronic device 101 may control an operation of a speaker of the electronic device 101 based on the first event (event #1) to significantly increase the volume of an output sound signal. The electronic device 101 may relay the first event (event #1) received from the host device 200 to the external electronic device 102. The external electronic device 102 may perform a function corresponding to the first event (event #1) in response to the reception of the first event (event #1). For example, the external electronic device 102 may control an operation of a speaker of the external electronic device 102 based on the first event (event #1) to significantly increase the volume of an output sound signal.

When a second event (event #2) (e.g., a pause command due to a user's touch) is generated from the electronic device 101 or the external electronic device 102, the device (e.g., the external electronic device 102) in which the second event (event #2) is generated may perform a function corresponding to the second event (event #2) and relay the second event (event #2) to the other device (e.g., the electronic device 101). For example, as the external electronic device 102 detects a user's touch, the external electronic device 102 may control an operation of a speaker to pause the output of a sound signal. The external electronic device 102 may transmit the second event (event #2) to the electronic device 101 and the host device 200. The electronic device 101 may perform a function corresponding to the second event (event #2) in response to the reception of the second event (event #2) from the external electronic device 102. For example, as the electronic device 101 receives the second event (event #2), the electronic device 101 may control an operation of a speaker to pause the output of a sound signal. The electronic device 101 may relay the second event (event #2) to the host device 200.

Referring to FIG. 5, a wireless communication connection between the host device 200, the electronic device 101, and the external electronic device 102 may be established, and data transmission and reception may be performed through the wireless communication connection. For example, the host device 200 and the electronic device 101 may be connected to each other (e.g., Bluetooth communication connection) through a wireless communication channel, and the host device 200 and the electronic device 101 may perform bidirectional communication for transmitting and receiving data or the like through the wireless communication channel. When a wireless communication connection between the electronic device 101 and the host device 200 is established, the external electronic device 102 may receive at least a portion of data received from the host device 200 to the electronic device 101 through a separate wireless communication connection. For example, the external electronic device 102 may monitor a wireless communication connection between the electronic device 101 and the host device 200 through a communication parameter. Here, the monitoring may mean a state in which the external electronic device 102 attempts to receive at least a portion of a packet transmitted through a wireless communication connection between the electronic device 101 and the host device 200 or a state in which the external electronic device 102 may receive at least a portion of a packet transmitted through the wireless communication connection between the electronic device 101 and the host device 200. The external electronic device 102 may obtain data transmitted and received between the electronic device 101 and the host device 200 through the wireless communication connection that is being monitored, which may be referred to as sniffing.

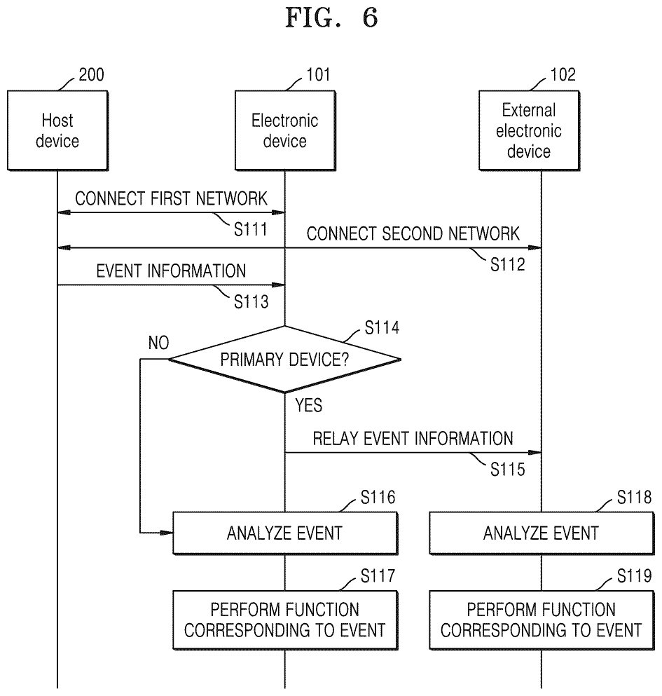

FIG. 6 is a flowchart illustrating a command processing method between a host device, an electronic device, and an external electronic device, according to one or more embodiments.

In detail, one or more embodiments according to a method of processing a command (e.g., an event) generated by the host device 200 is described in terms of each device with reference to FIG. 6. The electronic device 101, the external electronic device 102, and the host device 200 of FIG. 6 may correspond to the electronic device 101, the external electronic device 102, and the host device 200 of FIGS. 1, 2, and 3B to 5.

In FIG. 6, for convenience of explanation, it is assumed that the electronic device 101 is a primary device, and the external electronic device 102 is a secondary device. But, according to the situation of the devices (e.g., the battery capacity for each device), the external electronic device 102 may be changed to the primary device.

In operation S111, the host device 200 and the electronic device 101 may be connected to a first network, and the host device 200 and the external electronic device 102 may be connected to a second network. Here, the first network and the second network are wireless short-range communication networks, which may be Bluetooth communication networks. However, the second network may be a low-power-based Bluetooth communication network.

In operation S113, the host device 200 may transmit information about an event (e.g., a volume-up command) generated in the host device 200 to the electronic device 101.

In operation S114, the electronic device 101 may identify whether the electronic device 101 is a primary device. In operation S115, when the electronic device 101 is not a primary device, the electronic device 101 may relay the event information received from the host device 200 to the external electronic device 102.

In operation S116, when the electronic device 101 is a primary device, the electronic device 101 may analyze the received event information. For example, the electronic device 101 may decode the received event information to identify a function indicated by a command generated by the host device 200 (e.g., a ‘volume-up’ function by a speaker of the electronic device 101).

In operation S117, the electronic device 101 may perform a function corresponding to the event. For example, the electronic device 101 may amplify the size of a sound signal output by the speaker of the electronic device 101 and output the sound signal.

In operation S118, the external electronic device 102 may analyze the event information received from the electronic device 101. For example, the external electronic device 102 may decode the received event information and identify a function indicated by a command generated by the host device 200 (e.g., a ‘volume-up’ function by a speaker of the external electronic device 102).

In operation S119, the external electronic device 102 may perform a function corresponding to the event. For example, the external electronic device 102 may amplify the size of a sound signal output by the speaker of the external electronic device 102 and output the sound signal.

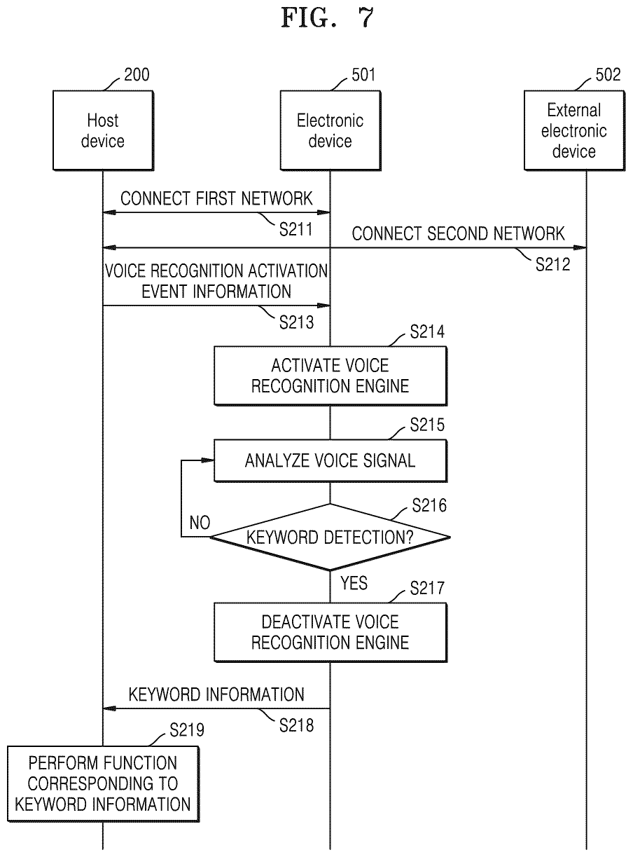

FIG. 7 is a flowchart illustrating a method of performing voice recognition between a host device, an electronic device, and an external electronic device, according to a comparative example.

In detail, a method of processing a command (e.g., an event) generated by the host device 200 according to a comparative example is described in terms of each device with reference to FIG. 7. The comparative example is one or more embodiments different from one or more embodiments according to the disclosure, and it is assumed that the same type of VREs are commonly stored (refer to FIG. 3A) in an electronic device 501 and an external electronic device 502.

In FIG. 7, for convenience of explanation, it is assumed that the electronic device 501 according to the comparative example is a primary device, and the external electronic device 502 is a secondary device.

Referring to FIG. 6 together, the descriptions of operations S211 and S212 of FIG. 7 overlap the descriptions of operations S111 and S112 of FIG. 6, and thus the descriptions are placed with the description of FIG. 6.

In operation S213, the host device 200 may transmit information about an event (e.g., a voice recognition activation command) generated in the host device 200 to the electronic device 501.

In operation S214, the electronic device 501 may activate a VRE. For example, the electronic device 501 may analyze the received event information and activate a VRE indicated by the received event information. A processor of the electronic device 501 may activate the VRE by loading a program code for the VRE stored in a memory thereof.

In operations S215 and S216, the electronic device 501 may analyze a voice signal and identify whether a keyword is detected in the voice signal. For example, the electronic device 501 may obtain a voice signal of the user through a microphone of the electronic device 501 and search for/detect a keyword from the obtained voice signal of the user. Here, the keyword may be a wake-up word (e.g., ‘Hi Bixby’ or the like) of a voice recognition function. When a keyword is detected from the voice signal of the user, the electronic device 501 may perform operation S217, and when a keyword is not detected from the voice signal of the user, the electronic device 501 may repeatedly perform operation S215.

In operation S217 and S218, the electronic device 501 may deactivate a VRE when a keyword is detected from the voice signal of the user, and may transmit information about the detected keyword (hereinafter, referred to as keyword information) to the host device 200.

In operation S219, the host device 200 may perform a function corresponding to the keyword information received from the electronic device 501. For example, the host device 200 may execute a voice recognition application based on the keyword information (e.g., ‘Hi Bixby’).

The electronic device 501 and the external electronic device 502 according to the comparative example may store the same type of VREs in each device, and the remaining battery capacity of a primary device is generally greater than the remaining battery capacity of a secondary device, and thus it may be confirmed that only the VRE stored in the primary device (e.g., the electronic device 501) is mainly used. Accordingly, the electronic device 501 and the external electronic device 502 according to the comparative example have the same VRE mounted thereon, which may have the limitation of providing only services based on a limited type of VRE.

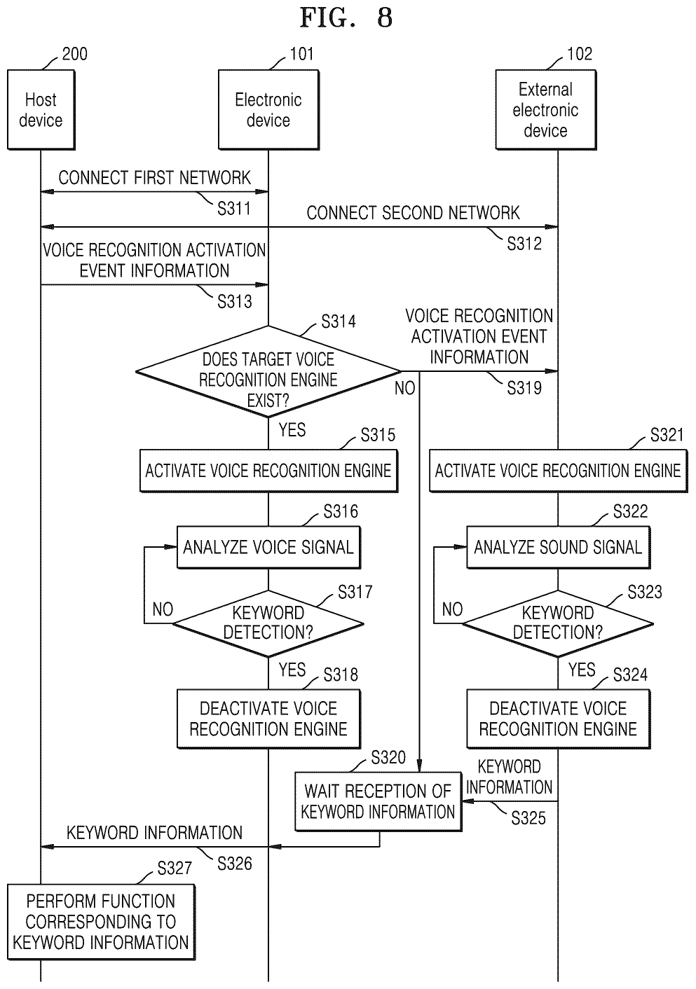

FIG. 8 is a flowchart illustrating a method of performing voice recognition between a host device, an electronic device, and an external electronic device, according to one or more embodiments.

In detail, one or more embodiments according to a method of processing a command (e.g., an event) generated by the host device 200 is described in terms of each device with reference to FIG. 8. The electronic device 101, the external electronic device 102, and the host device 200 of FIG. 8 may correspond to the electronic device 101, the external electronic device 102, and the host device 200 of FIGS. 1, 2, and 3B to 5.

In FIG. 8, for convenience of explanation, it is assumed that the electronic device 101 is a primary device, and the external electronic device 102 is a secondary device. But, according to the situation of the devices (e.g., the battery capacity for each device), the external electronic device 102 may be changed to the primary device.

Referring to FIG. 6 together, the descriptions of operations S311 and S312 of FIG. 8 overlap the descriptions of operations S111 and S112 of FIG. 6, and thus the descriptions are placed with the description of FIG. 6.

In operation S313, the host device 200 may transmit information about an event (e.g., a voice recognition activation command) generated in the host device 200 to the electronic device 101.

In operation S314, the electronic device 101 may identify whether a target VRE exists among the VREs stored in a memory of the electronic device 101, based on the voice recognition activation command information received from the host device 200. When a target VRE exists in the memory of the electronic device 101, operation S315 may be performed, and when a target VRE does not exist in the memory of the electronic device 101, operation S319 may be performed.

In operation S315, the electronic device 101 may activate the target VRE. For example, the electronic device 101 may analyze the received event information (e.g., the voice recognition activation event information) and activate the target VRE indicated by the received event information. A processor of the electronic device 101 may activate the target VRE by loading a program code for the target VRE among the VREs stored in the memory thereof.

In operations S316 and S317, the electronic device 101 may analyze a voice signal and identify whether a keyword is detected in the voice signal. For example, the electronic device 101 may obtain a voice signal of the user through a microphone of the electronic device 101 and search for/detect a keyword from the obtained voice signal of the user. Here, the keyword may be a wake-up word (e.g., ‘Hi Bixby’ or the like) of a voice recognition function. When a keyword is detected from the voice signal of the user, the electronic device 101 may perform operation S318, and when a keyword is not detected from the voice signal of the user, the electronic device 101 may repeatedly perform operation S316.

In operation S318, the electronic device 101 may deactivate the target VRE when a keyword is detected from the voice signal of the user. For example, the electronic device 101 may deactivate the target VRE in response to the detection of the keyword from the voice signal of the user.

In operation S319, when a target VRE does not exist in the memory of the electronic device 101, the electronic device 101 may transmit voice recognition activation event information received from the host device 200 to the external electronic device 102. In operation S320, the electronic device 101 may wait until keyword information is received from the external electronic device 102.

In operation S321, the external electronic device 102 may activate a target VRE. For example, the external electronic device 102 may analyze event information (e.g., voice recognition activation event information) received from the electronic device 101 and activate a target VRE indicated by the received event information. A processor of the external electronic device 102 may activate the target VRE by loading a program code for the target VRE among the VREs stored in the memory thereof.

In operations S322 and S323, the external electronic device 102 may analyze a voice signal and identify whether a keyword is detected from the voice signal. For example, the external electronic device 102 may obtain a voice signal of the user through a microphone of the external electronic device 102 and search for/detect a keyword from the obtained voice signal of the user. Here, the keyword may be a wake-up word (e.g., ‘Hi Bixby’ or the like) of a voice recognition function. When a keyword is detected from the voice signal of the user, the external electronic device 102 may perform operation S324, and when a keyword is not detected from the voice signal of the user, the external electronic device 102 may repeatedly perform operation S322.

In operation S324, the external electronic device 102 may deactivate the target VRE when a keyword is detected from the voice signal of the user. For example, the external electronic device 102 may deactivate the target VRE in response to the detection of the keyword from the voice signal of the user.

In operation S324, the external electronic device 102 may transmit information about the detected keyword (hereinafter, referred to as keyword information) to the electronic device 101.

In operation S325, the electronic device 101 may transmit the keyword information to the host device 200. For example, the electronic device 101 may transmit keyword information detected by the target VRE stored in the electronic device 101 or keyword information detected by the target VRE stored in the external electronic device 102 to the host device 200.

In operation S326, the host device 200 may perform a function corresponding to the keyword information received from the electronic device 101. For example, the host device 200 may execute a voice recognition application based on the keyword information (e.g., ‘Hi Bixby’).

A device and method according to one or more embodiments may allow various VREs to be mounted thereon despite limited memory capacity, and may provide the user with various voice recognition-based services based on the VREs by separately stored a plurality of CREs on the electronic device 101 and the external electronic device 102.

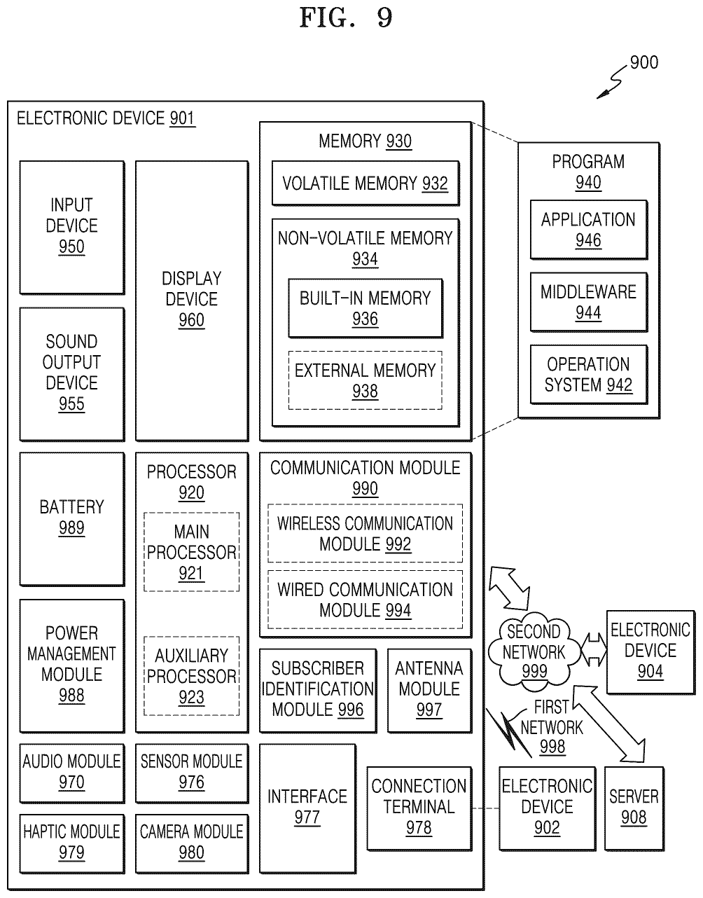

FIG. 9 shows a wireless network environment including an electronic device according to one or more embodiments.

In FIG. 9, an electronic device 901 may correspond to the host device 200 of FIG. 1, an electronic device 902 may correspond to a device (e.g., 100 in FIG. 1) including the electronic device 101 and/or the external electronic device 102 of FIG. 1, a first sub-device of the electronic device 902 may correspond to the electronic device 101 of FIG. 1, and a second sub-device thereof may correspond to the external electronic device 102 of FIG. 1. It is assumed that the first sub-device of the electronic device 902 is a primary device, and the second sub-device of the electronic device 902 is a secondary device. In some embodiments, electronic device 902 has a second processor operatively connected to a second memory storing second instructions. The second processor may be configured to execute the second instructions.

Referring to FIG. 9, in a network environment 900, the electronic device 901 (e.g., the host device 200, FIG. 1) may communicate with the electronic device 902 (e.g., the device set 100, FIG. 1) including the first sub-device and the second sub-device through a first network 998 (e.g., a short-range wireless communication network), or may communicate with an electronic device 904 or a server 908 through a second network 999 (e.g., a long-range wireless communication network). According to one or more embodiments, the electronic device 901 may communicate with the electronic device 904 through the server 908. According to one or more embodiments, the electronic device 901 may include a processor 920 (e.g., a main processor 921, auxiliary processor 923), a memory 930 (e.g., a volatile memory 932, non-volatile memory 934), an input device 950, a sound output device 955, a display device 960, an audio module 970, a sensor module 976, an interface 977, a haptic module 979, a camera module 980, a power management module 988, a battery 989, a communication module or communication interface 990 (e.g., a wireless communication module or wireless communication interface 992, wired communication module or wired communication interface 994), a subscriber identification module 996, or an antenna module 997. In some embodiments, at least one (e.g., the display device 960 or the camera module 980) of the components may be omitted in the electronic device 901, or one or more other components may be added. In some embodiments, some of the components may be implemented in one integrated circuit. For example, the sensor module 976 (e.g., a fingerprint sensor, an iris sensor, or an illuminance sensor) may be implemented by being embedded in the display device 960 (e.g., a display).

The processor 920 may, for example, control at least one other component (e.g., a hardware or software component) of the electronic device 901 connected to the processor 920 by executing software (e.g., a program 940), and may perform various data processing or calculations. According to one or more embodiments, as at least a part of data processing or calculation, the processor 920 may load a command or data received from other components (e.g., the sensor module 976 or the communication module 990) into a volatile memory 932, process the command or data stored in the volatile memory 932, and store result data in a non-volatile memory 934. According to one or more embodiments, the processor 920 may include a main processor 921 (e.g., a central processing device or an application processor) and an auxiliary processor 923 (e.g., a graphics processing device, an image signal processor, a sensor hub processor, or a communication processor) that may operate independently or together with the main processor 921. Additionally or generally, the auxiliary processor 923 may be set to use lower power than the main processor 921 or to be specialized in a specified function. The auxiliary processor 923 may be implemented separately from the main processor 921 or may be implemented as a part of the main processor 921.

The processor 920 may transmit event information (e.g., voice recognition activation event information) to the electronic device 902 (e.g., including the first sub-device and the second sub-device) on which a plurality of VREs are distributed and mounted to activate a target VRE stored in the electronic device 902. The first sub-device and the second sub-device of the electronic device 902 may separately store a plurality of different VREs in each device. For example, the first sub-device and the second sub-device of the electronic device 902 may select a VRE to be commonly stored in the first sub-device and the second sub-device based on the number of times of uses for each VRE and the user setting. For example, the first sub-device and the second sub-device of the electronic device 902 may select different VREs to be stored in each sub-device based on a sorting result according to the number of times of uses for each VRE.

The first sub-device (primary device) of the electronic device 902 (e.g., the electronic device 101) may identify whether a target VRE exists among the VREs stored in the memory of the first sub-device. When a target VRE exists in the first sub-device, the target VRE may be activated to transmit obtained keyword information to the electronic device 901. When a target VRE does not exist in the first sub-device, the event information may be transmitted to the second sub-device (secondary device) (e.g., the external electronic device 102). The second sub-device may activate the target VRE in response to the reception of the event information and transmit keyword information obtained based on the target VRE to the electronic device 901 through the first sub-device. The processor 920 may perform a function (e.g., a voice recognition application) corresponding to the received keyword information.

The auxiliary processor 923 may, for example, may control at least some of the functions or states related to at least one component (e.g., the display device 960, the sensor module 976, or the communication module 990) of the electronic device 901 by replacing the main processor 921 while the main processor 921 is in an inactive (e.g., sleep) state or by operating together with the main processor 921 while the main processor 921 is in an active (e.g., application execution) state. According to one or more embodiments, the auxiliary processor 923 (e.g., an image signal processor or a communication processor) may be implemented as part of other functionally related components (e.g., the camera module 980 or the communication module 990).

The memory 930 may store a variety of data used by at least one component (e.g., the processor 920 or the sensor module 976) of the electronic device 901. The data may include, for example, software (e.g., the program 940, or the first instructions) and input data or output data about commands related to the software. The memory 930 may include the volatile memory 932 or the non-volatile memory 934.

The program 940 may be stored in the memory 930 as software, and may include, for example, an operating system 942, middleware 944, or an application 946.

The input device 950 may receive a command or data to be used in a component (e.g., the processor 920) of the electronic device 901 from the outside of the electronic device 901 (e.g., the user). The input device 950 may include, for example, a microphone, a mouse, a keyboard, or a digital pen (e.g., a stylus pen).

The sound output device 955 may output a sound signal to the outside of the electronic device 901. The sound output device 955 may include, for example, a speaker or a receiver. The speaker may be used for general uses, such as multimedia playback or recording playback, and the receiver may be used to receive a call. According to one or more embodiments, the receiver may be implemented separately from the speaker or as a part of the speaker.

The display device 960 may visually provide information to the outside of the electronic device 901 (e.g., the user). The display device 960 may include, for example, a display, a hologram device, or a projector, and a control circuit configured to control a corresponding device. According to one or more embodiments, the display device 960 may include a touch circuitry that is set to detect a touch, or a sensor circuit (e.g., a pressure sensor) that is set to measure the intensity of force generated by the touch.

The audio module 970 may convert a sound into an electrical signal or may conversely convert an electrical signal into a sound. According to one or more embodiments, the audio module 970 may obtain a sound through the input device 950 or may output a sound through the sound output device 955 or an external electronic device (e.g., the electronic device 902 including the first sub-device and the second sub-device) directly or wirelessly connected to the electronic device 901.

The sensor module 976 may detect an operating state (e.g., power or temperature) of the electronic device 901 or an external environment state (e.g., a user state) and generate an electrical signal or data value corresponding to the detected state. According to one or more embodiments, the sensor module 976 may include, for example, a gesture sensor, a gyro sensor, an air pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols that may be used to directly or wirelessly connect the electronic device 901 to an external electronic device (e.g., the electronic device 902). According to one or more embodiments, the interface 977 may include, for example, a high definition multimedia interface (HDMI), a universal serial bus (USB) interface, an SD card interface, or an audio interface.

A connection terminal 978 may include a connector such that the electronic device 901 may be physically connected to an external electronic device (e.g., the electronic device 902) through the connector. According to one or more embodiments, the connection terminal 978 may include, for example, an HDMI connector, a USB connector, an SD card connector, or an audio connector (e.g., a headphone connector).

The haptic module 979 may convert an electrical signal into a mechanical stimulus (e.g., vibration or movement) or electrical stimulus that may be recognized by the user through touch or motor sensation. According to one or more embodiments, the haptic module 979 may include, for example, a motor, a piezoelectric element, or an electrical stimulus device.

The camera module 980 may capture still images and videos. According to one or more embodiments, the camera module 980 may include one or more lenses, image sensors, image signal processors, or flashes.

The power management module 988 may manage power supplied to the electronic device 901. According to one or more embodiments, the power management module 988 may be implemented, for example, as at least a part of a PMIC.

The battery 989 may supply power to at least one component of the electronic device 901. According to one or more embodiments, the battery 989 may include, for example, a primary battery that is non-rechargeable, a secondary battery that is rechargeable, or a fuel cell.

The communication module 990 may establish a direct (e.g., wired) communication channel or a wireless communication channel between the electronic device 901 and an external electronic device (e.g., the electronic device 902, the electronic device 904, or the server 908) and support communication performance through the established communication channel. The communication module 990 may include one or more communication processors that operates independently from the processor 920 (e.g., an application processor) and supports direct (e.g., wired) communication or wireless communication. According to one or more embodiments, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication module). A corresponding communication module among the communication modules may communicate with an external electronic device through the first network 998 (e.g., a short-range communication network such as Bluetooth, WiFi direct, or infrared data association (IrDa)) or the second network 999 (a long-range communication network such as a cellular network, the Internet, or a computer network (e.g., LAN or WAN). These various types of communication modules may be integrated into one component (e.g., a single chip) or may be implemented as a plurality of components (e.g., a plurality of chips). The wireless communication module 992 may confirm and authenticate the electronic device 901 within a communication network such as the first network 998 or the second network 999 by using subscriber information (e.g., the international mobile subscriber identity (IMSI) stored in the subscriber identification module 996.

The antenna module 997 may transmit a signal or power to the outside (e.g., an external electronic device) or receive a signal or power from the outside. According to one or more embodiments, the antenna module 997 may include one antenna including a conductor formed on a substrate (e.g., a printed circuit board (PCB)) or a radiator including a conductive pattern. According to one or more embodiments, the antenna module 997 may include a plurality of antennas. In this case, at least one antenna suitable for a communication method used in a communication network such as the first network 998 or the second network 999 may be selected, for example, from the plurality of antennas by the communication module 990. A signal or power may be transmitted or received between the communication module 990 and an external electronic device through the at least one selected antenna. According to some embodiments, other parts (e.g., a radio-frequency integrated circuit (RFIC)) in addition to the radiator may be formed as a part of the antenna module 997.

At least some of the components may communicate with each other and exchange signals (e.g., commands or data) with each other through communication methods between surrounding devices (e.g., general purpose input and output (GPIO), a serial peripheral interface (SPI), or a mobile industry processor interface (MIPI).

According to one or more embodiments, a command or data may be transmitted or received between the electronic device 901 and the electronic device 904 outside the electronic device 901 through the server 908 connected to the second network 999. The electronic devices 902 and 904 may be the same type device or different types of devices from the electronic device 901. According to one or more embodiments, all or some of the operations executed in the electronic device 901 may be executed in one or more external devices among the external electronic devices (e.g., 902, 904, or 908). For example, when the electronic device 901 must automatically perform a function or service or in response to a request from the user or another device, the electronic device 901 may additionally request one or more external electronic devices to perform at least a portion of the function or service instead of executing a function or service on its own. The one or more external electronic devices that have received the request may execute at least a portion of the requested function or service or an additional function or service related to the request and transmit an execution result to the electronic device 901. The electronic device 901 may provide the result received from the one or more external electronic devices as at least a portion of a response to the request or may provide the result as at least a portion of a response to the request by additionally processing the result. To this end, for example, cloud computing, distributed computing, or client-server computing technology may be used.

The host device 200 according to various embodiments may be various types of devices. An electronic device may include, for example, a portable communication device (e.g., a smartphone), a computer device, a portable multimedia device, a portable medical device, a camera, a wearable device, or a home appliance. The host device 200 according to one or more embodiments is not limited to the devices stated above.

The various embodiments and terms used therein are not to limit the technical features stated herein to particular embodiments, but it is to be appreciated that various changes, equivalents, and substitutes of the embodiments are encompassed. In the descriptions of the drawings, like reference numerals denote like elements. An expression used in the singular encompasses the expression of the plural, unless it has a clearly different meaning in the context. Herein, each of the phrases, such as “A or B,” “at least one of A and B,” “at least one of A or B,” “A, B, or C,” “at least one of A, B, and C,” and “at least one of A, B, or C” may include one of the items listed together with the corresponding phrase, or any possible combination thereof. It will be understood that although the terms “first,” “second,” etc. may be used herein to simply to distinguish one component from another, and these components should not be limited by these terms in other respects (e.g., the importance or order). When one (e.g., first) component is said to be “coupled” or “connected” to another (e.g., second) component with or without the terms “functionally” or “communicatively,” it means that the one component may be connected to the other component directly (e.g., wired), wirelessly, or through a third component.

According to various embodiments, each component of the above-described components may include singular or plural entities. According to various embodiments, one or more of the corresponding components or operations described above may be omitted, or one or more other components or operations may be added. Alternatively or additionally, a plurality of components (e.g., modules or programs or instructions) may be integrated into a single component. In this case, the integrated component may perform one or more functions of each of the plurality of components identically or similarly to those performed by the corresponding component of the plurality of components prior to the integration. According to various embodiments, the operations performed by a module, program, or other component may be executed sequentially, in parallel, iteratively, or heuristically, or one or more of the operations may be executed in a different order, omitted, or one or more other operations may be added.

While the disclosure has been particularly shown and described with reference to embodiments thereof, it will be understood that various changes in form and details may be made therein without departing from the spirit and scope of the following claims.

What is claimed is:

1. An electronic device comprising:
a speaker configured to output an audio signal;
a microphone configured to obtain a voice signal of a user;
a first memory storing a first voice recognition engine, a second voice recognition engine that is different from the first voice recognition engine, and instructions;
a communication interface configured to establish wireless communication connections with a host device and an external electronic device; and
at least one processor operatively connected to the speaker, the microphone, the first memory, and the communication interface, the at least one processor being configured to execute the instructions,
wherein the first voice recognition engine is commonly stored in the first memory and a second memory of the external electronic device, and
wherein the second voice recognition engine is different from voice recognition engines stored in the second memory.

2. The electronic device of claim 1, wherein the first voice recognition engine has a greatest number of uses during a predetermined period, among a plurality of voice recognition engines stored in the first memory and the second memory.

3. The electronic device of claim 2, wherein the at least one processor is configured to execute the instructions to:
count a number of uses of the plurality of voice recognition engines during the predetermined period, and
select and store a voice recognition engine with the greatest number of uses during the predetermined period among the plurality of voice recognition engines, as the first voice recognition engine.

4. The electronic device of claim 1, wherein the at least one processor is configured to execute the instructions to:
receive a command to perform voice recognition from the host device, and
identify whether a target voice recognition engine corresponding to the command is among voice recognition engines stored in the first memory.

5. The electronic device of claim 4, wherein the at least one processor is further configured to execute the instructions to, based on the target voice recognition engine being in the first memory:
obtain the voice signal of the user based on the target voice recognition engine,
based on detection of a keyword from the voice signal of the user, deactivate the target voice recognition engine, and
transmit information about the keyword to the host device.

6. The electronic device of claim 4, wherein the at least one processor is further configured to execute the instructions to, based on the target voice recognition engine not being in the first memory:
transmit the command received from the host device to the external electronic device,
receive, from the external electronic device, keyword information detected from the voice signal of the user by using the target voice recognition engine stored in the external electronic device, and
transmit the keyword information to the host device.

7. The electronic device of claim 1, wherein the electronic device is configured to:
refer to a primary device configured to operate in response to reception of a command from the host device, and
transmit the command to the external electronic device, and
wherein the external electronic device is configured to refer to a secondary device configured to operate based on the command received from the electronic device.

8. The electronic device of claim 7, wherein the at least one processor is configured to execute the instructions to:
identify a remaining battery capacity of the electronic device,
compare a remaining battery capacity of the external electronic device received from the external electronic device with the remaining battery capacity of the electronic device, and
change the external electronic device to the primary device and change the electronic device to the secondary device, based on a result of the comparison.

9. An electronic device comprising:
a speaker configured to output an audio signal;
a microphone configured to obtain a voice signal of a user;
a first memory storing a first voice recognition engine, a second voice recognition engine that is different from the first voice recognition engine, and instructions;
a communication interface configured to establish wireless communication connections with a host device and an external electronic device; and
at least one processor operatively connected to the speaker, the microphone, the first memory, and the communication interface, the at least one processor being configured to execute the instructions,
wherein the first voice recognition engine and the second voice recognition engine are different from voice recognition engines stored in a second memory of the external electronic device.

10. The electronic device of claim 9, wherein the first voice recognition engine and the second voice recognition engine are selected from a plurality of voice recognition engines based on any one of a number of uses for each of the plurality of voice recognition engines during a predetermined period, or a user setting.

11. The electronic device of claim 10, wherein the at least one processor is configured to execute the instructions to:
count the number of uses of each of the plurality of voice recognition engines during the predetermined period,
sort the plurality of voice recognition engines based on the number of uses of each of the plurality of voice recognition engines, and
select and store the first voice recognition engine and the second voice recognition engine according to an order of a greatest number of uses among the plurality of voice recognition engines, based on a result of the sorting.

12. The electronic device of claim 9, wherein the at least one processor is configured to execute the instructions to:
receive a command to perform voice recognition from the host device, and
identify whether a target voice recognition engine corresponding to the command is among voice recognition engines stored in the first memory.

13. The electronic device of claim 12, wherein the at least one processor is further configured to, based on the target voice recognition engine being in the first memory:
obtain the voice signal of the user based on the target voice recognition engine,
deactivate the target voice recognition engine in response to detection of a keyword from the voice signal of the user, and
transmit information about the keyword to the host device.

14. The electronic device of claim 12, wherein the at least one processor is further configured to, based on the target voice recognition engine not being in the first memory:
transmit the command received from the host device to the external electronic device,
receive, from the external electronic device, keyword information detected from the voice signal of the user by using a target recognition engine stored in the external electronic device, and
transmit the keyword information to the host device.

15. The electronic device of claim 9, wherein the electronic device is configured to:
based on reception of a command from the host device, refer to a primary device configured to operate; and
transmit the command to the external electronic device, and
wherein the external electronic device is configured to refer to a secondary device configured to operate based on the command received from the electronic device.

16. The electronic device of claim 15, wherein the at least one processor is configured to execute the instructions to:
identify a remaining battery capacity of the electronic device,
compare a remaining battery capacity of the external electronic device received from the external electronic device with the remaining battery capacity of the electronic device, and
change the external electronic device to the primary device and change the electronic device to the secondary device, based on a result of the comparison.

17. An electronic device comprising:
a first sub-device; and
a second sub-device,
wherein the first sub-device comprises:
a first speaker configured to output a first sound signal;
a first microphone;
a first wireless communication circuit configured to connect to the second sub-device via wireless communication;
a first memory storing a first voice recognition engine, a second voice recognition engine that is different from the first voice recognition engine, and first instructions; and
at least one first processor operatively connected to the first speaker, the first microphone, the first wireless communication circuit, and the first memory, the at least one first processor being configured to execute the first instructions, and
wherein the second sub-device comprises:
a second speaker configured to output a second sound signal;
a second microphone;
a second wireless communication circuit configured to connect to the first wireless communication circuit via wireless communication;
a second memory storing a third voice recognition engine, a fourth voice recognition engine that is different from the third voice recognition engine, and second instructions; and
at least one second processor operatively connected to the second speaker, the second microphone, the second wireless communication circuit, and the second memory, the at least one second processor being configured to execute the second instructions,
wherein the first voice recognition engine is the same as or different from the third voice recognition engine, and
wherein the second voice recognition engine is different from the fourth voice recognition engine.

18. The electronic device of claim 17, wherein the at least one first processor is configured to execute the first instructions to:
receive a command to perform voice recognition from a host device, and
identify whether a target voice recognition engine corresponding to the command is among the first voice recognition engine and the second voice recognition engine stored in the first memory.

19. The electronic device of claim 18, wherein the at least one first processor is further configured to execute the first instructions to, based on the target voice recognition engine being among the first voice recognition engine and the second voice recognition engine stored in the first memory:
obtain a voice signal of a user based on the target voice recognition engine,
based on detection of a keyword from the voice signal of the user, deactivate the target voice recognition engine, and
transmit information about the keyword to the host device.

20. The electronic device of claim 18, wherein the at least one first processor is further configured to execute the first instructions to, based on the target voice recognition engine not being among the first voice recognition engine and the second voice recognition engine stored in the first memory, transmit the command received from the host device to the second sub-device, and
wherein the at least one second processor is configured to execute the second instructions to, based on the target voice recognition engine not being among the first voice recognition engine and the second voice recognition engine stored in the first memory,
activate the target voice recognition engine corresponding to the command among the third voice recognition engine and the fourth voice recognition engine in response to reception of the command,
obtain a voice signal of a user based on the target voice recognition engine;
deactivate the target voice recognition engine in response to detection of a keyword from the voice signal of the user; and
transmit information about the keyword to the host device through the first sub-device.
